(19) United States
(12) Patent Application Publication
(10) Pub. No.: US 2025/0246026 A1
(43) Pub. Date: Jul. 31, 2025

(54) AVATAR GENERATION APPARATUS, AVATAR GENERATION METHOD AND NON-TRANSITORY COMPUTER-READABLE STORAGE MEDIUM

(71) Applicant: NEC Corporation, Minato-ku, Tokyo (JP)

(72) Inventors: Yoshiko IMANISHI, Tokyo (JP); Toru AOYAGI, Tokyo (JP)

(73) Assignee: NEC Corporation, Minato-ku, Tokyo (JP)

(21) Appl. No.: 18/698,825

(22) PCT Filed: Oct. 3, 2022
(86) PCT No.: PCT/JP2022/036957

§ 371 Date: Apr. 5, 2024

(30) Foreign Application Priority Data
Oct. 19, 2021 (JP) 2021-170852

(51) Int. Cl. G06V 40/60; G06T 11/00; G06V 40/16; G06V 40/20; G06V 40/50

(52) U.S. Cl. CPC G06V 40/67; G06T 11/00; G06V 40/172; G06V 40/20; G06V 40/50

(57) ABSTRACT

An avatar generation apparatus (10) includes an authentication unit (110) and an avatar generation unit (120). By using a first image including a target person and master information of the target person, the authentication unit (110) performs first authentication processing of the target person included in the first image. The avatar generation unit (120) generates an avatar of the target person by using the first image when the first authentication processing is successful. For example, the avatar is stored in a storage unit (140).

### TECHNICAL FIELD

The present invention relates to an avatar generation apparatus, an avatar generation method, and a storage medium.

### BACKGROUND ART

An avatar may be used in a virtual space or the like. For example, Patent Document 1 describes generation of an avatar of a participant in a video conference. In Patent Document 1, an avatar of a participant is generated based on preregistered avatar information. The avatar information is previously associated with facial recognition information in a table.

### RELATED DOCUMENT

### Patent Document

Patent Document 1: Japanese Patent Application Publication No. 2021-16083

### SUMMARY OF INVENTION

### Technical Problem

When an avatar is used, in order to guarantee credibility of a person represented by the avatar, authentication of the person needs to be performed before generation of the avatar. On the other hand, it is preferable for a person using an avatar to reduce a workload when generating the avatar.

An example of an object of the present invention is to guarantee credibility of a person represented by an avatar and reduce a workload required of the person when the avatar is generated.

### Solution to Problem

According to an embodiment of the present invention, an avatar generation apparatus including:
an authentication unit that, by using a first image including a target person and master information of the target person, performs first authentication processing of the target person included in the first image; and
an avatar generation unit that generates an avatar of the target person by using the first image when the first authentication processing is successful is provided.

According to an embodiment of the present invention, an avatar generation apparatus including:
an avatar generation unit that generates an avatar by using a first image including a target person; and
an authentication unit that performs first authentication processing of the target person included in the first image by using the first image and master information of the target person and sets the avatar to an authenticated avatar when authentication is successful is provided.

According to an embodiment of the present invention, an avatar generation method including, by a computer:
authentication processing of, by using a first image including a target person and master information of the target person, performing first authentication processing of the target person included in the first image; and
avatar generation processing of generating an avatar of the target person by using the first image when the first authentication processing is successful is provided.

According to an embodiment of the present invention, an avatar generation method including, by a computer:
avatar generation processing of generating an avatar by using a first image including a target person; and
authentication processing of performing first authentication processing of the target person included in the first image by using the first image and master information of the target person and setting the avatar to an authenticated avatar when authentication is successful is provided.

According to an embodiment of the present invention, a computer-readable storage medium on which a program is recorded, the program causing a computer to execute:
an authentication function of, by using a first image including a target person and master information of the target person, performing first authentication processing of the target person included in the first image; and
an avatar generation function of generating an avatar of the target person by using the first image when the first authentication processing is successful is provided.

According to an embodiment of the present invention, a computer-readable storage medium on which a program is recorded, the program causing a computer to execute:
an avatar generation function of generating an avatar by using a first image including a target person; and
an authentication function of performing first authentication processing of the target person included in the first image by using the first image and master information of the target person and setting the avatar to an authenticated avatar when authentication is successful is provided.

### Advantageous Effects of Invention

According to the embodiments of the present invention, credibility of a person represented by an avatar is guaranteed. Further, a workload required of the person when the avatar is generated is light.

### BRIEF DESCRIPTION OF DRAWINGS

FIG. 1 It is a diagram illustrating a use environment of an avatar generation apparatus according to an example embodiment.

FIG. 2 It is a diagram illustrating an example of a functional configuration of the avatar generation apparatus.

FIG. 3 A section (A) is a diagram illustrating an example of information being a source of master information, a section (B) is a diagram illustrating an example of a first image, and a section (C) is a diagram illustrating an example of an avatar.

FIG. 4 It is a diagram illustrating a hardware configuration example of the avatar generation apparatus.

FIG. 5 It is a diagram illustrating a first example of avatar generation processing performed by the avatar generation apparatus.

FIG. 6 It is a diagram illustrating an example of a screen displayed on a display of a terminal in Step S50 in FIG. 5.

FIG. 7 It is a diagram illustrating a second example of the avatar generation processing performed by the avatar generation apparatus.

FIG. 8 It is a diagram for illustrating a first example of second authentication processing.

FIG. 9 It is a diagram for illustrating a second example of the second authentication processing.

### DESCRIPTION OF EMBODIMENTS

Example embodiments of the present invention will be described below by using drawings. Note that in every drawing, similar components are given similar signs, and description thereof is omitted as appropriate.

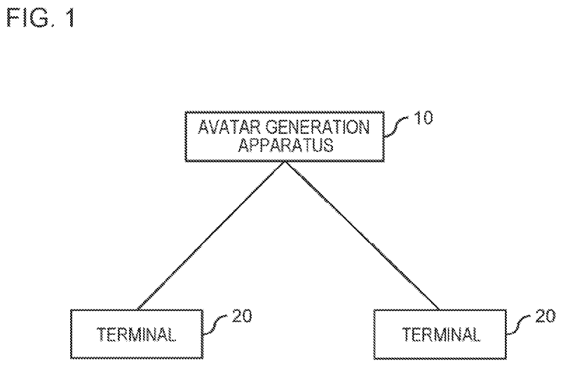

FIG. 1 is a diagram illustrating a use environment of an avatar generation apparatus 10 according to an example embodiment. The avatar generation apparatus 10 is an apparatus that generates an avatar of a person and, for example, is used with a terminal 20. The terminal 20 is a terminal operated by a user of the avatar generation apparatus 10. The terminal 20 may be a mobile terminal or a fixed terminal.

The terminal 20 includes an image capture unit and a display. A user of the avatar generation apparatus 10 generates an image of a person being a generation target of an avatar, that is, an image of a target person by operating the image capture unit in the terminal 20. The generated image is transmitted to the avatar generation apparatus 10. The image is hereinafter described as a first image. The first image may be a static image or a dynamic image. The avatar generation apparatus 10 performs authentication processing of a target person by using the first image. At this time, for example, the avatar generation apparatus 10 uses master information of the target person and the first image. The authentication processing is hereinafter described as first authentication processing. Then, when the first authentication processing is successful, the avatar generation apparatus 10 generates an avatar of the target person by using the first image and stores the avatar into a storage unit. The storage unit may be part of the avatar generation apparatus 10 or may be positioned outside the avatar generation apparatus 10. Further, the avatar generation apparatus 10 may cause the generated avatar to be displayed on the display of the terminal 20. Thus, the user of the terminal 20 can immediately check the avatar generated by the avatar generation apparatus 10. Note that the user of the terminal 20 and the target person may be identical or may be different.

There are various ways to use a generated avatar. For example, an avatar may be used in a virtual space. In this case, for example, the virtual space in which the avatar is used may be a game or a communication tool such as a virtual conference. Further, an avatar may be used in a social networking service (SNS). In this case, a person viewing an avatar displayed in the SNS recognizes that the avatar is an avatar of an owner himself/herself of the account and therefore is likely to feel a sense of closeness to the avatar. Further, a service using an avatar may be provided by the avatar generation apparatus 10 or may be provided by another server. In the latter case, the another server is connectable to the storage unit in which the avatar is stored.

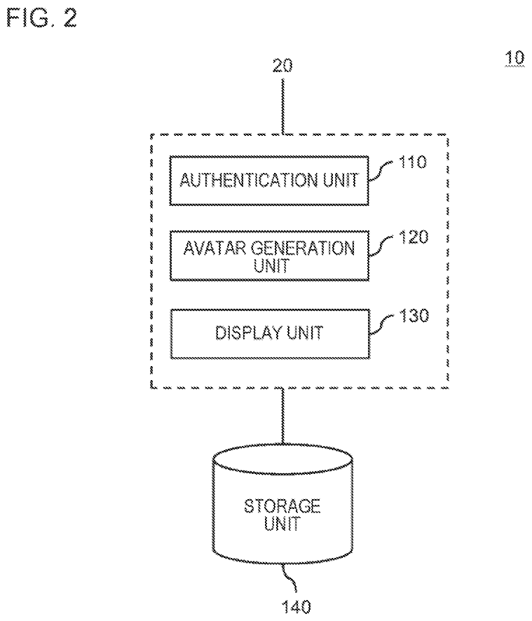

FIG. 2 is a diagram illustrating an example of a functional configuration of the avatar generation apparatus 10. The avatar generation apparatus 10 includes an authentication unit 110, an avatar generation unit 120, a display unit 130, and a storage unit 140.

The authentication unit 110 acquires a first image generated by the terminal 20 and performs the first authentication processing of a target person by using the first image and master information of the target person. For example, master information is information guaranteed to be facial information of a target person. As an example, master information may be preregistered in a storage unit such as the storage unit 140. In this case, the storage unit in which the master information is stored may be positioned outside the avatar generation apparatus 10.

Further, as another example, master information may be generated by using an image in which a personal identification document including an image of a target person such as a facial image of the target person is captured. In this case, the authentication unit 110 acquires an image of the target person through, for example, the terminal 20 and generates master information by using the image. Examples of a personal identification document include a license and a passport but are not limited thereto. Further, when a personal identification document includes a nonvolatile memory and an image of a target person is stored in the nonvolatile memory, the authentication unit 110 may generate master information by using the image.

When the first authentication processing is successfully performed by the authentication unit 110, such as when a degree of matching between a person included in a first image and master information exceeds a reference value, the avatar generation unit 120 generates an avatar by using the first image. Then, the avatar generation unit 120 stores the generated avatar into the storage unit 140. The avatar generation unit 120 may also store the first image tied to the avatar into the storage unit 140. Note that when the authentication unit 110 generates master information by using an image of a target person included in a personal identification document, the avatar generation unit 120 may also store the master information tied to the avatar into the storage unit 140.

The avatar generation unit 120 may generate an avatar by using an image of a target person included in a personal identification document in place of a first image.

The display unit 130 causes an avatar to be displayed on a display. At this time, the display unit 130 may cause information indicating that the first authentication processing is successful to be displayed on the display along with the avatar. The display indicates that the displayed avatar is based on an image used in successful first authentication processing, in other words, the avatar is a personally identified avatar. For example, the displayed information includes a sentence indicating that the first authentication processing is successful. Note that an example of a display on which an avatar or the like is caused to be displayed by the display unit 130 is the display of the terminal 20. In this case, a user of the terminal 20 can recognize that the first authentication processing is successful.

Note that the authentication unit 110 may perform second authentication processing on a target person after the avatar generation unit 120 generates an avatar. The authentication unit 110 may use the avatar generated by the avatar generation unit 120 in the second authentication processing. A specific example of the second authentication processing will be described later by using another diagram.

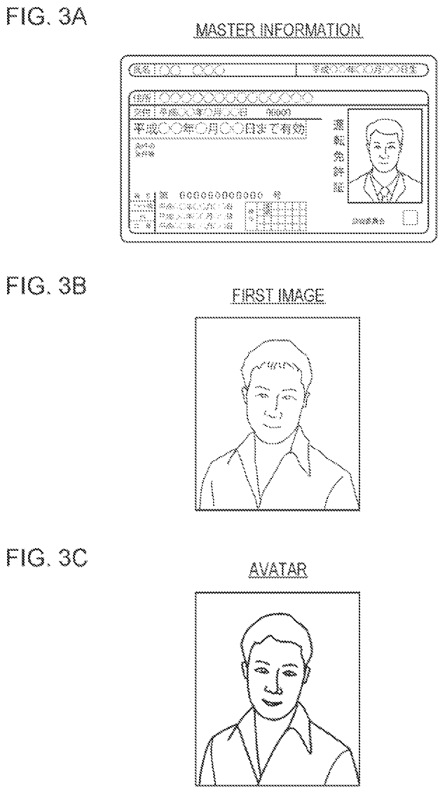

A section (A) in FIG. 3 is a diagram illustrating an example of information being a source of master information, a section (B) in FIG. 3 is a diagram illustrating an example of a first image, and a section (C) in FIG. 3 is a diagram illustrating an example of an avatar. In the example illustrated in the section (A) in FIG. 3, the authentication unit 110 generates master information by using a facial image included in a license. In the example illustrated in the section (B) in FIG. 3, the first image is a facial image of a target person. Then, in the example illustrated in the section (C) in FIG. 3, the avatar inherits a feature of the facial image included in the first image.

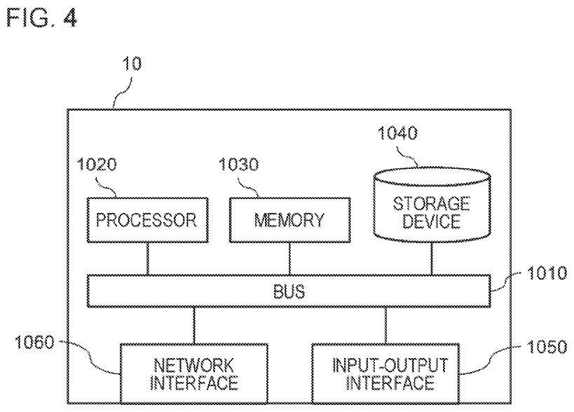

FIG. 4 is a diagram illustrating a hardware configuration example of the avatar generation apparatus 10. The avatar generation apparatus 10 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from each other. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk drive (HDD), a solid-state drive (SSD), a removable medium such as a memory card, a read-only memory (ROM), or the like. Program modules providing the functions of the avatar generation apparatus 10 (such as the authentication unit 110, the avatar generation unit 120, and the display unit 130) are stored in the storage device 1040. By reading each program module into the memory 1030 and executing the program module by the processor 1020, each function related to the program module is provided. The storage device 1040 also functions as the storage unit 140.

The input-output interface 1050 is an interface for connecting the avatar generation apparatus 10 to various types of input/output equipment.

The network interface 1060 is an interface for connecting the avatar generation apparatus 10 to a network. Examples of the network include a local area network (LAN) and a wide area network (WAN). The method for connecting the network interface 1060 to the network may be a wireless connection or a wired connection. Then, the avatar generation apparatus 10 communicates with the terminal 20 through the network interface 1060.

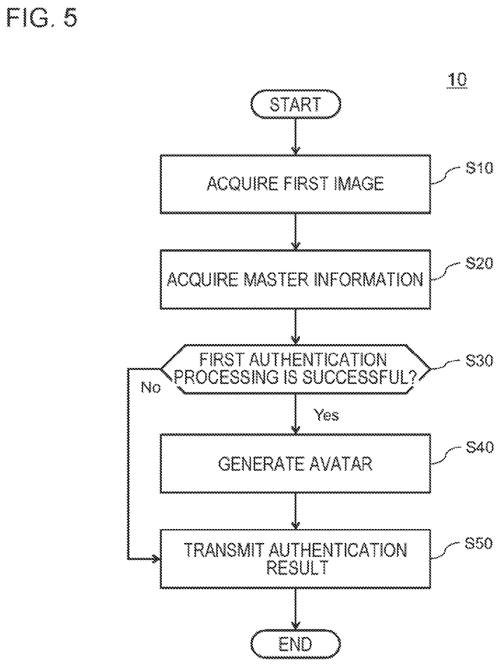

FIG. 5 is a diagram illustrating a first example of avatar generation processing performed by the avatar generation apparatus 10.

First, a user of the terminal 20 generates a first image by operating the terminal 20. The terminal 20 transmits the generated first image to the avatar generation apparatus 10. The authentication unit 110 in the avatar generation apparatus 10 acquires the first image from the terminal 20 (Step S10).

Next, the authentication unit 110 acquires master information (Step S20). When master information is stored in the storage unit 140, the authentication unit 110 reads the master information from the storage unit 140. Further, when master information is generated from an image of a personal identification document, the user of the terminal 20 generates an image of the personal identification document by operating the terminal 20. The terminal 20 transmits the generated image to the avatar generation apparatus 10. By processing the image, the authentication unit 110 generates master information in Step S20.

Note that the order of Step S10 and Step S20 may be reversed. Further, Step S10 and Step S20 may be performed simultaneously.

Next, the authentication unit 110 computes a degree of matching between the first image and the master information and determines that the first authentication processing is successful when the degree of matching is equal to or greater than the reference value (Step S30: Yes). Then, the avatar generation unit 120 generates an avatar by using the first image (Step S40).

Then, the display unit 130 transmits information indicating the authentication result to the terminal 20 and causes the information to be displayed on the display of the terminal 20. For example, when the first authentication processing is successful (Step S30: Yes), the display unit 130 causes the avatar generated in Step S40 to be displayed on the display of the terminal 20 (Step S50). Further, when the first authentication processing is unsuccessful (Step S30: No), the display unit 130 causes a screen indicating that the authentication is unsuccessful to be displayed on the display of the terminal 20 (Step S50).

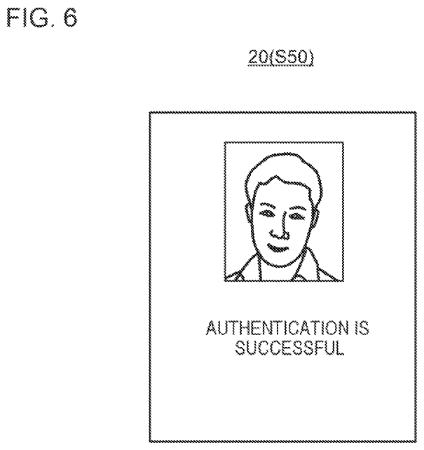

FIG. 6 is a diagram illustrating an example of a screen displayed on the display of the terminal 20 in Step S50 in FIG. 5. The diagram illustrates a screen displayed when the first authentication processing is successful in Step S30. The screen includes the avatar generated in Step S40 and a sentence indicating that the first authentication processing is successful.

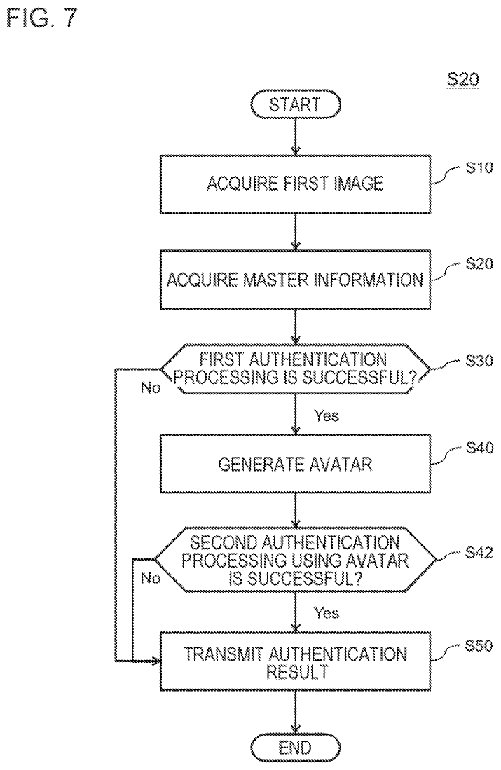

FIG. 7 is a diagram illustrating a second example of the avatar generation processing performed by the avatar generation apparatus 10. In the example illustrated in the diagram, processing in Step S10 to Step S40 is similar to the example illustrated in FIG. 5.

After the avatar generation unit 120 generates an avatar, the authentication unit 110 performs the second authentication processing using the avatar. A specific example of the second authentication processing will be described later by using another diagram. When the second authentication processing is successful (Step S42: Yes), the display unit 130 causes a screen indicating that the authentication is successful to be displayed on the display of the terminal 20. Otherwise (Step S30: No or Step S42: No), the display unit 130 causes a screen that the authentication is unsuccessful to be displayed on the display of the terminal 20.

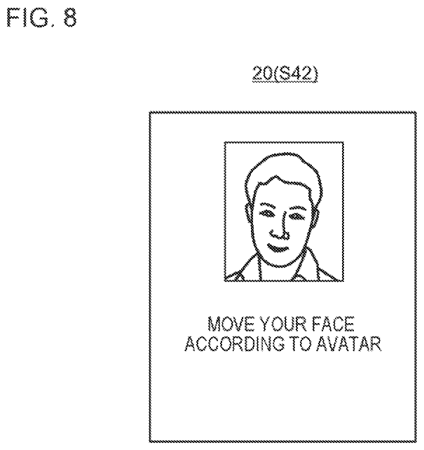

FIG. 8 is a diagram for illustrating a first example of the second authentication processing performed in Step S42 in FIG. 7. FIG. 8 illustrates an example of a screen caused to be displayed on the display of the terminal 20 by the authentication unit 110 in the second authentication processing (Step S42 in FIG. 7). In the example illustrated in the diagram, the authentication unit 110 checks whether a target person performs a specified action on the spot, as the second authentication processing. Consequently, the authentication unit 110 can check whether the target person exists at the spot.

Specifically, the authentication unit 110 causes the avatar to be displayed on the display of the terminal 20. Then, the authentication unit 110 causes the avatar to perform a first action to be performed by the target person. Since the avatar is an avatar of the target person, the target person feels a sense of closeness to the avatar. Accordingly, the target person is less likely to feel psychological resistance when performing the first action. The target person viewing the display of the terminal 20 performs the first action according to the avatar. The terminal 20 generates a second image by capturing an image of the target person while the target person performs the first action and transmits the second image to the avatar generation apparatus 10. The second image is preferably a dynamic image. When the second image is a dynamic image, the frame rate of the dynamic image may be any rate.

By processing the second image, the authentication unit 110 in the avatar generation apparatus 10 recognizes an action performed by the target person after the avatar performs the first action. Then, the authentication unit 110 performs the second authentication processing by using the recognized action and the first action. As an example, the authentication unit 110 determines that the authentication of the target person is successful when a degree of matching between the recognized action and the first action is equal to or greater than a reference value.

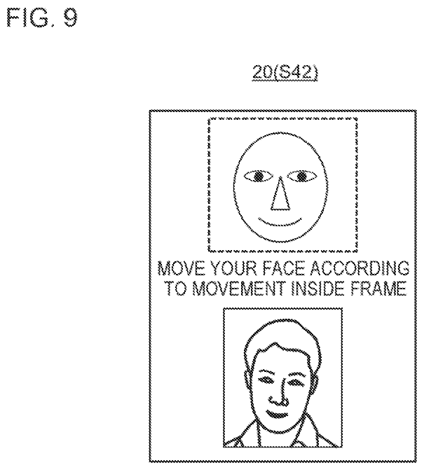

FIG. 9 is a diagram for illustrating a second example of the second authentication processing performed in Step S42 in FIG. 7. FIG. 9 illustrates an example of a screen caused to be displayed on the display of the terminal 20 by the authentication unit 110 in the second authentication processing (Step S42 in FIG. 7). In the example illustrated in the diagram as well, the authentication unit 110 checks whether the target person performs a specified action on the spot, as the second authentication processing. In the example in FIG. 9, the authentication unit 110 causes information indicating the first action to be displayed on the display of the terminal 20 as illustrated in an upper region of FIG. 9 and causes the second image to be displayed on the display of the terminal 20 as illustrated in a lower region of FIG. 9. Further, in the example in FIG. 9, the authentication unit 110 causes the target person captured in the second image to be displayed on the display of the terminal 20 in a state of being replaced by the avatar. Even in such a case, the target person feels a sense of closeness to the avatar and therefore is less likely to feel psychological resistance when performing the first action. At this time, the authentication unit 110 may not cause a region other than the target person in the second image to be displayed on the display. For example, the information indicating the first action may be an image in which a character other than the avatar performs the first action.

Note that the display unit 130 uses the generated avatar in an SNS or a virtual space as described by using FIG. 1.

In the description above, the avatar generation unit 120 and the display unit 130 are provided in the avatar generation apparatus 10 being an apparatus different from the terminal 20. However, the avatar generation unit 120 may be provided in the terminal 20. In this case, the authentication unit 110 transmits information indicating that the first authentication processing is successful to the terminal 20. Then, the avatar generation unit 120 in the terminal 20 generates an avatar by using a first image. Then, the display unit 130 in the terminal 20 performs processing using the avatar.

Note that in FIG. 5 and FIG. 7, the order of Step S30 and Step S40 may be reversed. In other words, the authentication unit 110 may perform the first authentication processing after the avatar generation unit 120 generates an avatar by using a first image. In this case, when the first authentication processing is successful, the authentication unit 110 sets the avatar generated by the avatar generation unit 120 to an authenticated avatar. Further, when the first authentication processing is unsuccessful, the authentication unit 110 does not set the avatar to an authenticated avatar.

As described above, the avatar generation apparatus 10 according to the present example embodiment performs the first authentication processing before generating an avatar. Therefore, credibility of a person represented by the avatar is guaranteed. Further, the avatar generation apparatus 10 generates an avatar by using a first image used in the first authentication processing. Therefore, a user of the avatar generation apparatus 10 does not need to separately prepare an image being a source of the avatar. Accordingly, a workload when an avatar is generated is reduced.

While the example embodiments of the present invention have been described above with reference to the drawings, the example embodiments are exemplifications of the present invention, and various configurations other than those described above may be employed.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the contents in each example embodiment. Further, the aforementioned example embodiments may be combined without contradicting each other.

The whole or part of the example embodiments disclosed above may also be described as, but not limited to, the following supplementary notes.

1. An avatar generation apparatus including:
an authentication unit that, by using a first image including a target person and master information of the target person, performs first authentication processing of the target person included in the first image; and
an avatar generation unit that generates an avatar of the target person by using the first image when the first authentication processing is successful.
   2. An avatar generation apparatus including:
an avatar generation unit that generates an avatar by using a first image including a target person; and
an authentication unit that performs first authentication processing of the target person included in the first image by using the first image and master information of the target person and sets the avatar to an authenticated avatar when authentication is successful.
   3. The avatar generation apparatus according to aforementioned 1 or 2, further including
a display unit that causes information indicating that the first authentication processing is successful to be displayed on a display along with the avatar.
   4. The avatar generation apparatus according to any one of aforementioned 1 to 3, in which
the authentication unit further performs second authentication processing of the target person by using the avatar after the avatar generation unit generates the avatar.
   5. The avatar generation apparatus according to aforementioned 4, in which,
in the second authentication processing, the authentication unit
   causes the avatar to perform a first action to be performed by the target person and
   recognizes, by processing a second image in which the target person is captured, an action performed by the target person after the avatar performs the first action and performs the second authentication processing by using the action and the first action.
      6. The avatar generation apparatus according to aforementioned 4, in which
the authentication unit
   acquires a second image in which the target person is captured for the second authentication processing and,
   in the second authentication processing, causes information indicating a first action to be performed by the target person to be displayed on a display and causes the second image to be displayed on the display in a state of the target person captured in the second image being replaced by the avatar.
      7. The avatar generation apparatus according to any one of aforementioned 1 to 6, in which,
in the first authentication processing, the authentication unit acquires an image of the target person included in a personal identification document of the target person and generates the master information by using the image.
   8. An avatar generation method including, by a computer:
authentication processing of, by using a first image including a target person and master information of the target person, performing first authentication processing of the target person included in the first image; and
avatar generation processing of generating an avatar of the target person by using the first image when the first authentication processing is successful.
   9. An avatar generation method including, by a computer:
avatar generation processing of generating an avatar by using a first image including a target person; and
authentication processing of performing first authentication processing of the target person included in the first image by using the first image and master information of the target person and setting the avatar to an authenticated avatar when authentication is successful.
   10. The avatar generation method according to aforementioned 8 or 9, further including, by the computer,
display processing of causing information indicating that the first authentication processing is successful to be displayed on a display along with the avatar.
   11. The avatar generation method according to any one of aforementioned 8 to 10, in which,
in the authentication processing, the computer further performs second authentication processing of the target person by using the avatar after the avatar is generated.
   12. The avatar generation method according to aforementioned 11, in which,
in the second authentication processing, the computer
   causes the avatar to perform a first action to be performed by the target person and
   recognizes, by processing a second image in which the target person is captured, an action performed by the target person after the avatar performs the first action and performs the second authentication processing by using the action and the first action.
      13. The avatar generation method according to aforementioned 11, in which,
in the authentication processing, the computer
   acquires a second image in which the target person is captured for the second authentication processing and,
   in the second authentication processing, causes information indicating a first action to be performed by the target person to be displayed on a display and causes the second image to be displayed on the display in a state of the target person captured in the second image being replaced by the avatar.
      14. The avatar generation method according to any one of aforementioned 8 to 13, in which,
in the first authentication processing, the computer acquires an image of the target person included in a personal identification document of the target person and generates the master information by using the image.
   15. A program causing a computer to execute:
an authentication function of, by using a first image including a target person and master information of the target person, performing first authentication processing of the target person included in the first image; and
an avatar generation function of generating an avatar of the target person by using the first image when the first authentication processing is successful.
   16. A program causing a computer to execute:
an avatar generation function of generating an avatar by using a first image including a target person; and
an authentication function of performing first authentication processing of the target person included in the first image by using the first image and master information of the target person and setting the avatar to an authenticated avatar when authentication is successful.
   17. The program according to aforementioned 15 or 16, further causing the computer to execute
a display function of causing information indicating that the first authentication processing is successful to be displayed on a display along with the avatar.
   18. The program according to any one of aforementioned 15 to 17, in which
the authentication function further performs second authentication processing of the target person by using the avatar after the avatar generation function generates the avatar.
   19. The program according to aforementioned 18, in which,
in the second authentication processing, the authentication function
   causes the avatar to perform a first action to be performed by the target person and
   recognizes, by processing a second image in which the target person is captured, an action performed by the target person after the avatar performs the first action and performs the second authentication processing by using the action and the first action.
      20. The program according to aforementioned 18, in which
the authentication function
   acquires a second image in which the target person is captured for the second authentication processing and,
   in the second authentication processing, causes information indicating a first action to be performed by the target person to be displayed on a display and causes the second image to be displayed on the display in a state of the target person captured in the second image being replaced by the avatar.
      21. The program according to any one of aforementioned 15 to 20, in which,
in the first authentication processing, the authentication function acquires an image of the target person included in a personal identification document of the target person and generates the master information by using the image.

This application claims priority based on Japanese Patent Application No. 2021-170852 filed on Oct. 19, 2021, the disclosure of which is hereby incorporated by reference thereto in its entirety.

### REFERENCE SIGNS LIST

10 Avatar generation apparatus
20 Terminal
110 Authentication unit
120 Avatar generation unit
130 Display unit

What is claimed is:

1. An avatar generation apparatus comprising:
at least one memory configured to store instructions; and
at least one processor configured to execute the instructions to perform operations comprising:
performing by using a first image including a target person and master information of the target person, first authentication processing of the target person included in the first image; and
generating an avatar of the target person by using the first image when the first authentication processing is successful.

2. (canceled)

3. The avatar generation apparatus according to claim 1, wherein the operations further comprise
causing information indicating that the first authentication processing is successful to be displayed on a display along with the avatar.

4. The avatar generation apparatus according to claim 1, wherein the operations further comprise
performing second authentication processing of the target person by using the avatar after the avatar is generated.

5. The avatar generation apparatus according to claim 4, wherein the operations further comprise,
in the second authentication processing,
causing the avatar to perform a first action to be performed by the target person and
recognizing, by processing a second image in which the target person is captured, an action performed by the target person after the avatar performs the first action and performing the second authentication processing by using the action and the first action.

6. The avatar generation apparatus according to claim 4, wherein
the operations further comprise
acquiring a second image in which the target person is captured for the second authentication processing and,
in the second authentication processing, causing information indicating a first action to be performed by the target person to be displayed on a display and causing the second image to be displayed on the display in a state of the target person captured in the second image being replaced by the avatar.

7. The avatar generation apparatus according to claim 1, wherein the operations further comprise,
in the first authentication processing, acquiring an image of the target person included in a personal identification document of the target person and generating the master information by using the image.

8. An avatar generation method comprising, by a computer:
authentication processing of, by using a first image including a target person and master information of the target person, performing first authentication processing of the target person included in the first image; and
avatar generation processing of generating an avatar of the target person by using the first image when the first authentication processing is successful.

9. (canceled)

10. The avatar generation method according to claim 8, further comprising, by the computer,
display processing of causing information indicating that the first authentication processing is successful to be displayed on a display along with the avatar.

11. The avatar generation method according to claim 8, wherein,
in the authentication processing, the computer further performs second authentication processing of the target person by using the avatar after the avatar is generated.

12. The avatar generation method according to claim 11, wherein,
in the second authentication processing, the computer
causes the avatar to perform a first action to be performed by the target person and
recognizes, by processing a second image in which the target person is captured, an action performed by the target person after the avatar performs the first action and performs the second authentication processing by using the action and the first action.

13. The avatar generation method according to claim 11, wherein,
in the authentication processing, the computer
acquires a second image in which the target person is captured for the second authentication processing and,
in the second authentication processing, causes information indicating a first action to be performed by the target person to be displayed on a display and causes the second image to be displayed on the display in a state of the target person captured in the second image being replaced by the avatar.

14. The avatar generation method according to claim 8, wherein,
in the first authentication processing, the computer acquires an image of the target person included in a personal identification document of the target person and generates the master information by using the image.

15. A non-transitory computer-readable storage medium storing a program for causing a computer to perform operations comprising:
performing by using a first image including a target person and master information of the target person, first authentication processing of the target person included in the first image; and
generating an avatar of the target person by using the first image when the first authentication processing is successful.

16. (canceled)

17. The non-transitory computer-readable storage medium according to claim 15, wherein
the operations further comprise causing information indicating that the first authentication processing is successful to be displayed on a display along with the avatar.

18. The non-transitory computer-readable storage medium according to claim 15, wherein
the operations further comprise performing second authentication processing of the target person by using the avatar after the avatar is generated.

19. The non-transitory computer-readable storage medium according to claim 18, wherein the operations further comprise,
in the second authentication processing,
causing the avatar to perform a first action to be performed by the target person and
recognizing, by processing a second image in which the target person is captured, an action performed by the target person after the avatar performs the first action and performing the second authentication processing by using the action and the first action.

20. The non-transitory computer-readable storage medium according to claim 18, wherein
the operations further comprise
acquiring a second image in which the target person is captured for the second authentication processing and,
in the second authentication processing, causing information indicating a first action to be performed by the target person to be displayed on a display and causing the second image to be displayed on the display in a state of the target person captured in the second image being replaced by the avatar.

21. The non-transitory computer-readable storage medium according to claim 15, wherein the operations further comprise,
in the first authentication processing, acquiring an image of the target person included in a personal identification document of the target person and generating the master information by using the image.
